(19) United States
(12) Patent Application Publication
(10) Pub. No.: US 2002/0020427 A1
(43) Pub. Date: Feb. 21, 2002

(54) Dental floss bar

(76) Inventor: Wan-Fang Lin, Changhua Hsien (TW)

Correspondence Address: Charles E. Baxley, Hart, Baxley, Daniels & Holton, 59 John Street, Fifth Floor, New York, NY, 10038, US

(21) Appl. No.: 09/864,351

(22) Filed: May 25, 2001

(30) Foreign Application Priority Data
Aug. 18, 2000 (TW) 089214355

(51) Int. Cl. A61C 15/00

(52) U.S. Cl. 132/325; 132/321

(57) ABSTRACT

A floss bar includes a handle having a recess and a lid is snapped to the handle to close the recess in which a blade and a roll of floss are received. Two protrusions extend from the bar and each of the two protrusions has grooves defined in an outer periphery thereof. A longitudinal groove is defined in each of the two protrusions so that a section of floss can be tied in the respective grooves of the two protrusions.

### FIELD OF THE INVENTION

The present invention relates to a floss bar which has a head with a lid and toothpicks and floss are received therein. Two protrusions extend from the bar and each of which has grooves for the floss connected between the two protrusions.

### BACKGROUND OF THE INVENTION

A conventional dental floss bar 13 is shown in FIG. 1 and includes a handle and two protrusions 131. A section of floss 11 is fixedly connected between the two protrusions 131 so that users may hold the handle of the bar 13 and clean the teeth by the floss 11. A distal end of the handle of the bar 13 is a sharp end which is used as a tooth pick and the sharp end could hurt the users and is difficult to be stored in pockets. A floss retainer 10 is popularly used because a roll of floss 11 is received therein. A blade 12 is connected to the retainer 10 so that the users may cut the floss 11 at desired length. It requires skills to use the floss 11 without the floss bar especially for the kids and aged people.

The present invention intends to provide a floss bar that has toothpicks and floss received therein and the floss can be cut and connected between two protrusions on the bar.

### SUMMARY OF THE INVENTION

In accordance with one aspect of the present invention, there is provided a floss bar and comprises a handle having a recess defined in a surface thereof and a lid is snapped on the surface. A blade is located in the recess and a roll of floss is received in the recess. Two protrusions extend from the bar and each of the two protrusions having grooves defined in an outer periphery thereof and a longitudinal groove defined therein. A section of floss can be tied in the respective grooves of the two protrusions.

The primary object of the present invention is to provide a dental floss bar that is convenient to be stored and carried and toothpicks are received in the bar.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show two types of conventional floss device;

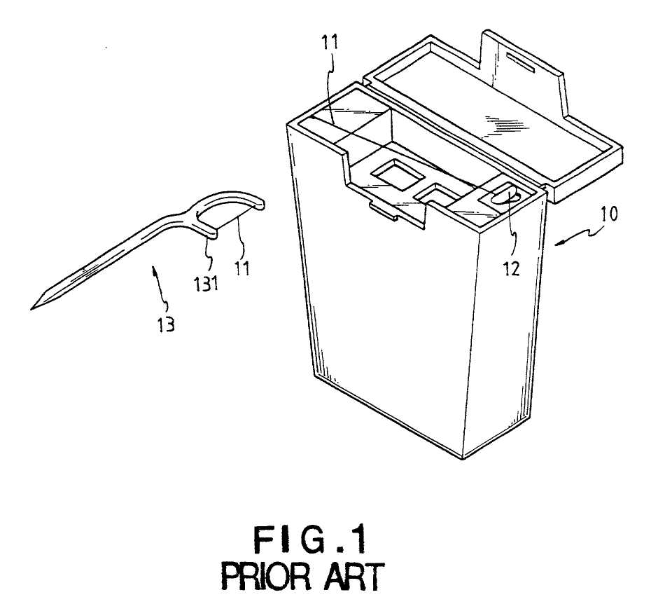

FIG. 2 is a perspective view to show a dental floss bar of the present invention wherein a lid is opened;

FIG. 3 is a cross sectional view to show the dental floss bar of the present invention;

FIG. 4 is a perspective view to show the dental floss bar of the present invention wherein the lid is closed, and

FIG. 5 is a cross sectional view to show the dental floss bar of the present invention and a toothpick is connected to a protrusion of the bar.

### DETAILED DESCRIPTION OF THE PREFERRED EMBODIMENT

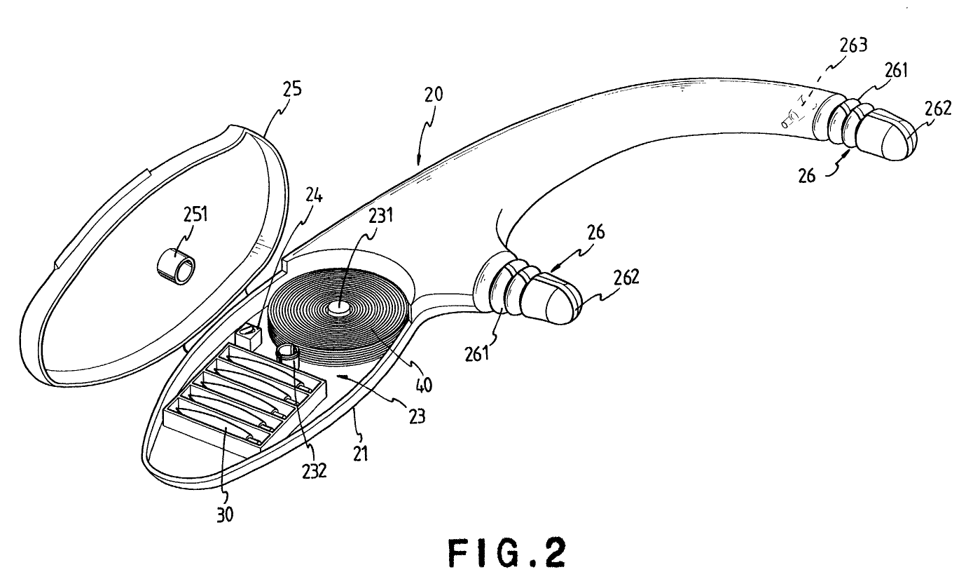

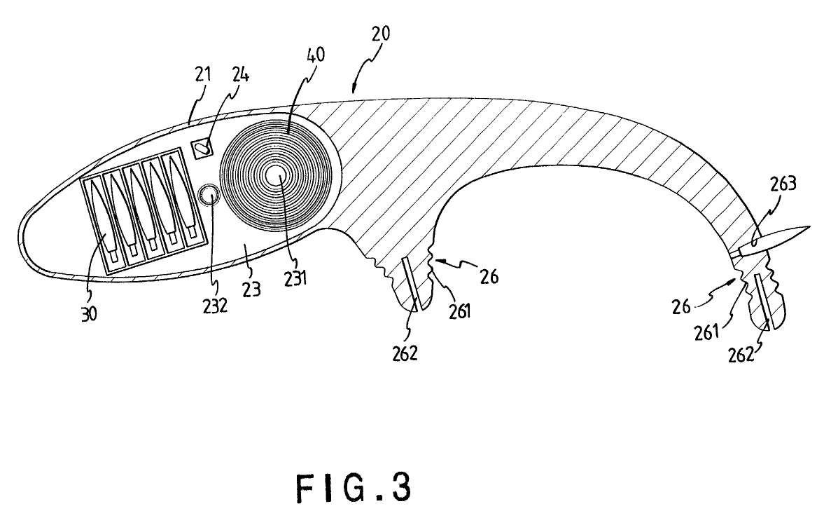

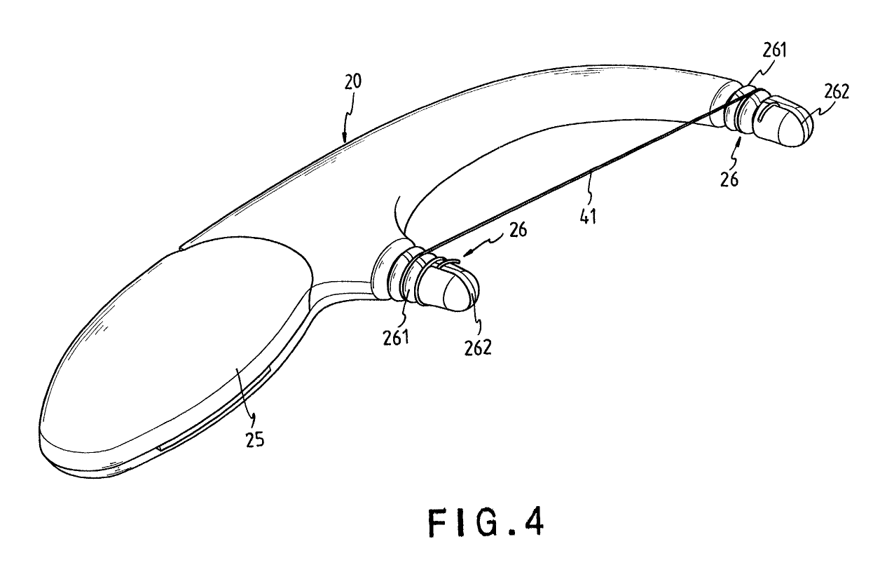

Referring to FIGS. 2 to 4, the dental floss bar 20 of the present invention comprises a handle 21 having a recess 23 defined in a surface thereof and a lid 25 is pivotally connected to the surface. The lid 25 is easily snapped on the surface to close the recess 23. A first tube 232 extends from an inside of the recess 23 and a second tube 251 extends from the lid 25 so that the second tube 251 is engaged with the first tube 232 when the lid 25 is in close position. A roll of floss 40 is mounted on a shaft 231 and received in the recess 23, and a blade 24 is located in the recess 23 and beside the roll of the floss 40. The section 41 of floss can be cut by the blade 24.

Two protrusions 26 extend from the bar 20 and each of the two protrusions 26 has grooves 261 defined in an outer periphery thereof. A longitudinal groove 262 is defined in each of the two protrusions 26 so that a section 41 of floss can be tied in the respective grooves 261 of the two protrusions 26, and two ends of the section 41 of floss are respectively fixed in the two longitudinal grooves 262.

A box of toothpicks 30 is stored in the recess 23 and an engaging notch 263 is defined in an outer periphery of one of the protrusions 26 so that a toothpick 30 can be engaged with the engaging notch 263.

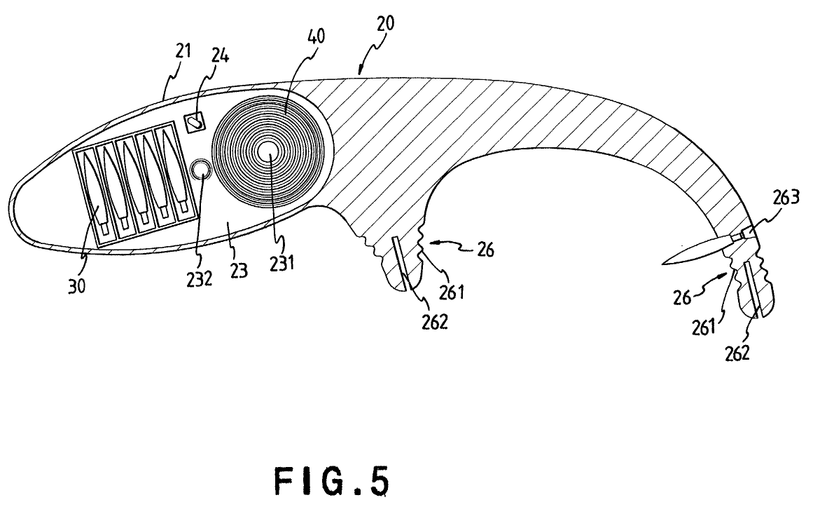

FIG. 5 shows that the number of the engaging notches 263 are defined in the same protrusion 26 so that the toothpick 30 can be connected to the protrusion 26 in different orientations so as to meet different needs when using the toothpick 30.

While we have shown and described the embodiment in accordance with the present invention, it should be clear to those skilled in the art that further embodiments may be made without departing from the scope of the present invention.

What is claimed is:

1. A floss bar comprising:
a handle having a recess defined in a surface thereof and a lid snapped on said surface, a blade located in said recess and a roll of floss received in said recess, and
two protrusions extending from said bar and each of said two protrusions having grooves defined in an outer periphery thereof, a longitudinal groove defined in each of said two protrusions.

2. The floss bar as claimed in claim 1, wherein said lid is pivotally connected to said handle of said bar.

3. The floss bar as claimed in claim 1, wherein one of said two protrusions has an engaging notch defined in an outer periphery thereof.
